(19) United States
(12) Patent Application Publication
(10) Pub. No.: US 2012/0146421 A1
(43) Pub. Date: Jun. 14, 2012

(54) FUEL CELL SYSTEM

(75) Inventor: Kenji Umayahara, Miyoshi-shi (JP)

(73) Assignee: TOYOTA JIDOSHA KABUSHIKI KAISHA, Toyota-shi (JP)

(21) Appl. No.: 13/390,777

(22) PCT Filed: Aug. 17, 2009
(86) PCT No.: PCT/JP2009/064401

§ 371 Date: Feb. 16, 2012

(51) Int. Cl. H02J 1/00

(52) U.S. Cl. 307/80

(57) ABSTRACT

An output of a fuel cell is appropriately controlled. A required electric power generation amount calculation unit calculates and adds: an amount of electric power to be supplied to a traction motor; an amount of electric power to be supplied to an auxiliary apparatus; and an amount of electric power to be supplied to a battery and the traction motor in accordance with the charging and discharging of the battery, to calculate a required electric power generation amount. A lost electric power amount calculation unit calculates a lost electric power amount with reference to a lost electric power amount map based on: the required electric power generation amount; and a voltage increase ratio, output voltage and temperature in an FC converter. A lost electric power amount addition unit corrects the required electric power generation amount by adding the lost electric power amount to the required electric power generation amount. An electric power generation request unit outputs an instruction requesting power generation such that the electric power is generated in the required electric power generation amount after being corrected.

### TECHNICAL FIELD

The present invention relates to a fuel cell system.

1. Background Art

Patent Document 1 below discloses a fuel cell system comprising an FC converter that boosts an output voltage of a fuel cell. In this fuel cell system, the FC converter is feedback-controlled such that an input current to the FC converter becomes a target current.

2. Prior Art References

### Patent Document

Patent Document 1: Japanese laid-open patent publication No. 2007-318938

### SUMMARY OF THE INVENTION

### Problem to be Solved by the Invention

In Patent Document 1 above, a target current is calculated based on target electric power of a motor; however, the electric power output from a fuel cell may be consumed by components other than the motor. Accordingly, unless the output of the fuel cell is controlled taking into consideration the consumption by the components other than the motor, an amount of electric power supplied to the motor may be decreased to less than a required amount of electric power. Depending on the degree of the decrease, for example, torque of the motor could be suppressed compared with a target torque and thus the drivability could be deteriorated, and an amount of electric discharge from a battery could be increased more than a target amount and thus overdischarge could be caused.

The present invention has been made to solve the above-described problem in the related art, and an object of the present invention is to provide a fuel cell system capable of appropriately controlling an output of a fuel cell.

### Means for Solving the Problem

In order to solve the problem above, the fuel cell system according to the present invention comprises: a fuel cell that is supplied with a fuel gas and an oxidant gas and that generates electric power through an electrochemical reaction between the fuel gas and oxidant gas; a power storage unit that is capable of being charged with the generated electric power of the fuel cell; an electric power-consuming apparatus that consumes electric power from the fuel cell and/or the power storage unit; a voltage conversion unit arranged between the fuel cell and the electric power-consuming apparatus; a required electric power generation amount calculation means that calculates a required electric power generation amount to be requested to the fuel cell; and a lost electric power amount calculation means that calculates a lost electric power amount to be lost in the voltage conversion unit, wherein the required electric power generation amount calculation means is supplemented with the lost electric power amount when calculating the required electric power generation amount.

According to the present invention, when calculating the required electric power generation amount to be requested to the fuel cell, the lost electric power amount to be lost in the voltage conversion unit can be calculated and added to the required electric power generation amount. This enables requesting the fuel cell to generate electric power in accordance with the required electric power generation amount having added thereto the lost electric power amount which is to be lost in the voltage conversion unit, and thus the situation in which the amount of electric power supplied to the electric power-consuming apparatus decreases to less than the required amount of electric power can be suppressed as much as possible.

In the above-described fuel cell system, the required electric power generation calculation means may be supplemented with the lost electric power amount by adding the lost electric power amount to other amounts of electric power generation included in the required electric power generation amount.

In the above-described fuel cell system, the lost electric power amount calculation means may calculate the lost electric power amount by making use of: an amount of electric power either input to the voltage conversion unit or output from the voltage conversion unit; and at least one parameter out of a pressure increase ratio in the voltage conversion unit, an output voltage in the voltage conversion unit and a temperature of the voltage conversion unit. In addition, the lost electric power amount calculation means may calculate the lost electric power amount by making use of: an amount of electric power input to the voltage conversion unit; and an amount of electric power output from the voltage conversion unit.

In the above-described fuel cell system, the electric power-consuming apparatus may include: a motor serving as a main power source; and an auxiliary apparatus necessary for actuating the fuel cell.

### Effect of the Invention

According to the present invention, an output of a fuel cell can be appropriately controlled.

### BRIEF DESCRIPTION OF THE DRAWINGS

FIG. 1 is a diagram schematically showing a configuration of a fuel cell system in an embodiment.

FIG. 2 is a diagram showing a specific example of a lost electric power amount map.

FIG. 3 is a flow chart for explaining a flow of FC converter output limitation processing in an embodiment.

### BEST MODE FOR CARRYING OUT THE INVENTION

A preferred embodiment of the fuel cell system according to the present invention will be described below with reference to the attached drawings. The following description describes an embodiment in which the fuel cell system according to the present invention is used as an on-board electric power generation system in a fuel cell hybrid vehicle (FCHV). Note that the fuel cell system according to the present invention is also applicable to various mobile objects (a robot, marine vessel, airplane, etc.) other than a fuel cell hybrid vehicle, and also to a stationary electric power generation system used as electric power generation facilities for establishments (a house, a building, etc.).

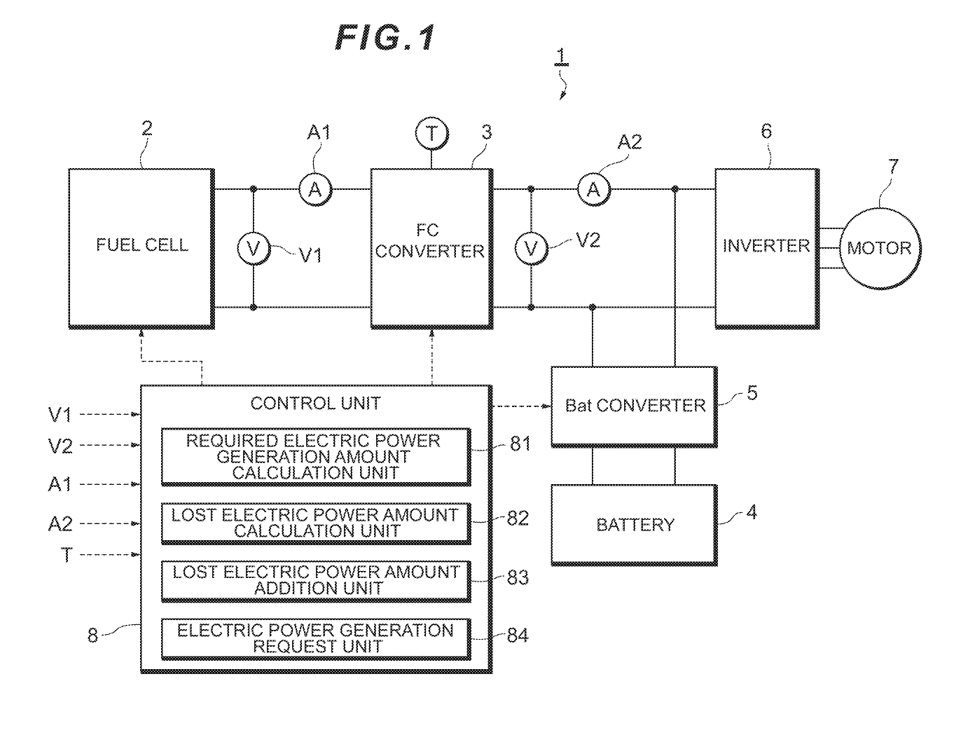

First, with reference to FIG. 1, the configuration of a fuel cell system in the present embodiment will be described. FIG. 1 is a diagram schematically showing a fuel cell system in the present embodiment.

As shown in FIG. 1, a fuel cell system 1 includes: a fuel cell 2 which generates electric power through an electrochemical reaction between an oxidant gas and a fuel gas serving as reactant gasses; a DC/DC converter (voltage conversion unit, hereinafter referred to as an “FC converter”) 3 for the fuel cell; a battery (power storage unit) 4 serving as a secondary cell; a DC/DC converter (hereinafter referred to as a “Bat converter”) 5 for the battery; a traction inverter 6 and a traction motor 7 (power-consuming apparatuses), both serving as loads; and a control unit 8 which centrally controls the entire system.

The fuel cell 2 is, for example, a polymer electrolyte type, which has a stack structure with a lot of unit cells stacked therein. Each unit cell has an air electrode on one surface of an electrolyte constituted from an ion-exchange membrane and a fuel electrode on the other surface of the electrolyte, and the unit cell further has a pair of separators which sandwich the air electrode and the fuel electrode therebetween. In this configuration, hydrogen serving as a fuel gas is supplied to a fuel gas path of one separator while oxygen serving as an oxidant gas is supplied to an oxidant gas path of the other separator, and electric power is generated through a chemical reaction between these reactant gasses. The fuel cell 2 is provided, on its output side, with a voltage sensor V1 which detects an output voltage of the fuel cell 2 and a current sensor Al which detects an output current of the fuel cell 2.

The FC converter 3 is a direct-current voltage converter, which has a function of increasing a direct-current voltage output from the fuel cell 2 and outputting the increased direct-current voltage to the traction inverter 6 being a power-consuming apparatus. The FC converter 3 controls the output voltage of the fuel cell 2. The FC converter 3 is provided, on its output side, with a voltage sensor V2 which detects an output voltage of the FC converter 3 and a current sensor A2 which detects an output current of the FC converter 3. The FC converter 3 is provided with a temperature sensor T which detects a temperature of the FC converter 3. The temperature sensor T detects the temperature of the FC converter 3 by, for example, detecting a temperature of cooling water for cooling the FC converter 3.

The battery 4 includes stacked battery cells and provides a certain high voltage as a terminal voltage, and the battery 4 is capable of being charged with surplus electric power of the fuel cell 2 and supplying electric power in an auxiliary manner under the control of a battery computer (not shown).

The Bat converter 5 is a direct-current voltage converter, which has a function of: increasing a direct-current voltage input from the battery 4 and outputting the increased direct-current voltage to the traction inverter 6 being a power-consuming apparatus; and decreasing a direct-current voltage input from either side of the fuel cell 2 or traction motor 7 and outputting the decreased direct-current voltage to the battery 4. Due to these functions of the Bat converter 5, charging and discharging of the battery 4 are carried out. For example, when a charge amount of the battery 4 exceeds the set range serving as a target, the Bat converter 5 discharges electric power from the battery 4 and outputs the discharged electric power to the traction inverter 6. On the other hand, when a charge amount of the battery 4 drops below a set range serving as a target, the Bat converter 5 charges the battery 4 by outputting output electric power of the fuel cell 2 to the battery 4.

The traction inverter 6 converts a direct current to a three-phase alternating current, and supplies the three-phase alternating current to the traction motor 7. The traction motor 7 is, for example, a three-phase alternating current motor, which constitutes a main power source for the fuel cell hybrid vehicle equipped with the fuel cell system 1.

The control unit 8 detects an amount of operation of an acceleration member (an accelerator, etc.) provided in the fuel cell hybrid vehicle, receives control information such as an acceleration request value (e.g., the amount of electric power generation required by power-consuming apparatuses such as the traction motor 7), and controls the operation of various appliances in the system. The power-consuming apparatuses may include, in addition to the traction motor 7, various auxiliary apparatuses. Examples of the auxiliary apparatuses may include FC auxiliary apparatuses required for actuating the fuel cell 2 and vehicle auxiliary apparatuses involving the vehicle, other than the fuel cell 2. Examples of the FC auxiliary apparatuses include motors for a compressor, a fuel pump and a cooling water pump, etc. Examples of vehicle auxiliary apparatuses include: actuators for a speed change gear, a wheel control apparatus, a steering gear and suspension; and an air conditioner, lighting equipment, audio system, etc., provided in a passenger compartment.

The control unit 8 physically includes, for example: a CPU; memory;

and an input-output interface. The memory includes: ROM that stores a control program and control data which are processed by the CPU; and RAM which is primarily used as an area for various operations for control processing. These elements are connected to each other via a bus. The input-output interface is connected to various sensors such as the voltage sensors V and the current sensors A, as well as various drivers for driving the traction motor 7, etc.

The CPU carries out various types of control processing in the fuel cell system 1 by receiving detection results from various sensors via the input-output interface and processing the received detection results by using various pieces of data, etc., in the RAM, based on the control program stored in the ROM. Also, the CPU controls the entire fuel cell system 1 by outputting control signals to various drivers via the input-output interface. The following description will describe FC output control processing, which is specific to the present embodiment, among various types of control processing carried out by the control unit 8.

The control unit 8 functionally includes, for example: a required electric power generation amount calculation unit (required electric power generation amount calculation means) 81; a lost electric power amount calculation unit (lost electric power amount calculation means) 82; a lost electric power amount addition unit (required electric power generation amount calculation means) 83; and an electric power generation request unit 84.

The required electric power generation amount calculation unit 81 calculates the amount of electric power generation required (hereinafter referred to as the “required electric power generation amount”) for the fuel cell 2. The required electric power generation amount corresponds to, for example, the amount of electric power to be supplied to the traction motor 7, the amount of electric power to be supplied to the FC auxiliary apparatuses, the amount of electric power to be supplied to the vehicle auxiliary apparatuses, and the amount of electric power to be supplied to the battery 4 and the traction motor 7 in accordance with the charging and discharging of the battery 4, etc. The required electric power generation amount calculation unit 81 calculates these various amounts of electric power to be supplied, and calculates the required electric power generation amount by adding each of these various amounts. The amount of electric power to be supplied to the traction motor 7 may be calculated, for example, based on the number of rotations of the traction motor 7, an acceleration opening degree, and vehicle speed, etc.

The lost electric power amount calculation unit 82 calculates the amount of electric power lost (hereinafter referred to as the “lost electric power amount”) in the FC converter 3. The lost electric power amount calculation unit 82 calculates the lost electric power amount by making use of the required electric power generation amount (in other words, the amount of electric power input to the FC converter 3) calculated by the required electric power generation amount calculation unit 81 and each parameter of the FC converter 3. Examples of the parameters include a pressure increase ratio in the FC converter 3, an output voltage of the FC converter 3, and a temperature of the FC converter 3, etc. The pressure increase ratio in the FC converter 3 may be calculated by determining the ratio of the detected value of the voltage sensor V1 to the detected value of the voltage sensor V2. The output voltage of the FC converter 3 may be calculated by determining the detected value of the voltage detector V2. The temperature of the FC converter 3 may be calculated by determining the detected value of the temperature sensor T.

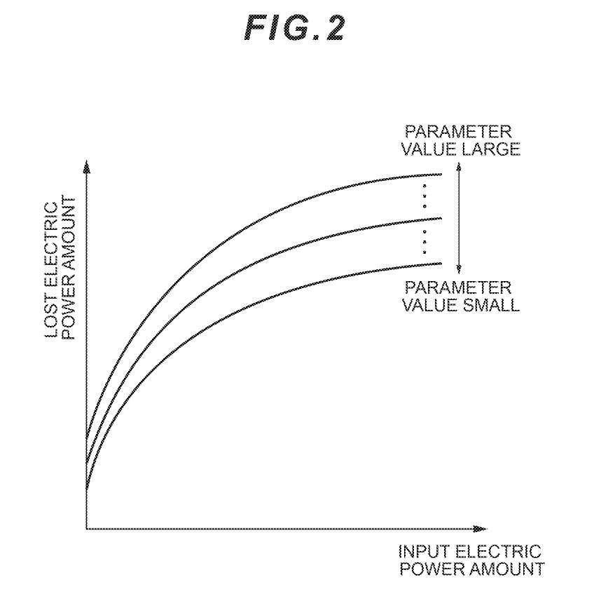

Specifically, the lost electric power amount calculation unit 82 calculates the lost electric power amount with reference to a lost electric power amount map based on the amount of electric power input to the FC converter 3 and each of the parameters described above. As illustrated in FIG. 2, the lost electric power amount map corresponds to a table indicating a correlation between: the amount of electric power input to the FC converter 3 and each of the parameters described above; and the lost electric power amount. The lost electric power amount map may be obtained in advance through experiments, etc., and stored in the memory. Between: the amount of electric power input to the FC converter 3 and each of the parameters described above; and the lost electric power amount, a correlation exists wherein the greater the amount of electric power input to the FC converter 3 and the values of each of the parameters are, the greater the lost electric power amount is.

Note that not all of the parameters described above need to be used, and any one of the parameters may be used. Also, the parameters are not limited to the parameters described above, and other parameter(s) may be used as long as the lost electric power amount can be calculated therewith in accordance with the amount of electric power input to the FC converter 3.

In addition, the lost electric power amount may be calculated with reference to a lost electric power amount map described below based on the amount of electric power output from the FC converter 3 and each of the parameters of the FC converter 3. The lost electric power amount map in this situation corresponds to a table indicating a correlation between: the amount of electric power output from the FC converter 3 and each of the parameters described above; and the lost electric power amount.

Moreover, the lost electric power amount may be calculated, without reference to the lost electric power amount map, by subtracting the amount of electric power input to the FC converter 3 from the amount of electric power output from the FC converter 3. The amount of electric power output from the FC converter 3 may be calculated by making use of the detected value of the voltage sensor V2 and the detected value of the current sensor A2. The amount of electric power input to the FC converter 3 may be calculated by making use of the detected value of the voltage sensor V1 and the detected value of the current sensor A1.

The lost electric power amount addition unit 83 shown in FIG. 1 corrects the required electric power generation amount by adding the lost electric power amount calculated by the lost electric power amount calculation unit 82 to the required electric power generation amount calculated by the required electric power generation amount calculation unit 81.

The electric power generation request unit 84 outputs an instruction requesting electric power generation to the fuel cell 2 such that the power is generated in the required electric power generation amount after being corrected by the lost electric power amount addition unit 83.

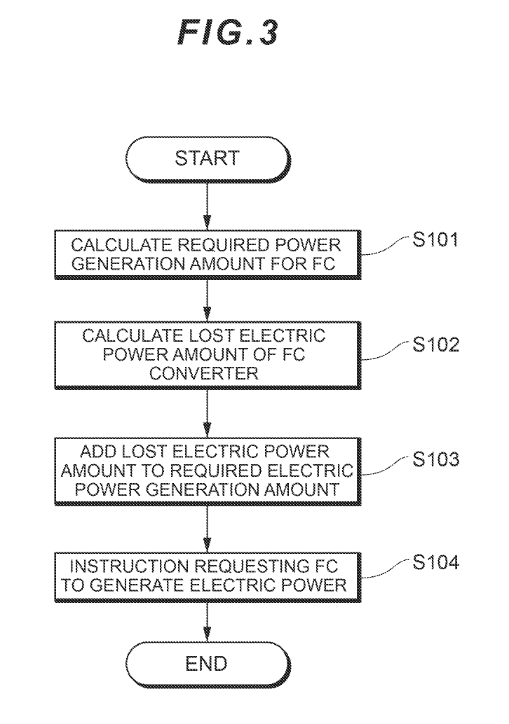

Next, the flow of FC output control processing in the present embodiment will be explained by making use of the flow chart shown in FIG. 3. The FC output control processing starts, for example, when an ignition key is turned and is repeatedly carried out until the driving ends.

First, the required electric power generation amount calculation unit 81 calculates the required electric power generation amount for the fuel cell 2 by adding various amounts of supplied electric power (step S101).

Next, the lost electric power amount calculation unit 82 calculates the lost electric power amount of the FC converter 3 with reference to the lost electric power amount map based on the required electric power generation amount calculated in step S101 described above and each parameter (step S102).

Next, the lost electric power amount addition unit 83 adds the lost electric power amount calculated in step S102 described above to the required electric power generation amount calculated in step S101 described above (step S103).

Next, the electric power generation request unit 84 outputs an instruction requesting power generation to the fuel cell such that the power is generated in the required electric power generation amount calculated in step S103 described above (step S104).

As described above, according to the fuel cell system 1 in the present embodiment, when calculating the required electric power generation amount to be requested to the fuel cell 2, the lost electric power amount, which is to be lost in the FC converter, can be calculated and added to the required electric power generation amount. This enables requesting the fuel cell 2 to generate electric power in accordance with the required electric power generation amount having added thereto the lost electric power amount which is to be lost in the FC converter. Accordingly, the situation in which the amount of the electric power supplied to the traction motor 7 decreases to less than the required amount of electric power can be suppressed as much as possible. Therefore, the output of the fuel cell can be appropriately controlled.

Note that in the embodiment described above, although the lost electric power amount calculated in the lost electric power amount calculation unit 82 is added to the required electric power generation amount calculated in the required electric power generation amount calculation unit 81, the method of calculating the required electric power generation amount is not limited thereto. For example, the required electric power generation amount calculation unit 81 may calculate the lost electric power amount at the time of calculating various amounts of electric power to be supplied, and the lost electric power amount may be added at the time of adding the various amounts of electric power to be supplied to calculate the required electric power generation amount. In this situation, it is only necessary to include each of the functions described above of the lost electric power amount calculation unit 82 in the functioning of the required electric power generation amount calculation unit 81. Namely, it may be sufficient if the required electric power generation amount calculation unit 81 is supplemented with the lost electric power amount when calculating the required electric power generation amount.

In addition, in the embodiment described above, although the required electric power generation amount is corrected by making use of the lost electric power amount of the FC converter 3, the method of correcting the required electric power generation amount is not limited thereto. For example, the required electric power generation amount may be corrected by calculating efficiency of the FC converter 3 and dividing the required electric power generation amount by the efficiency. The efficiency of the FC converter 3 is calculated with reference to an efficiency map based on the required electric power generation amount (amount of electric power input to the FC converter 3) calculated by the required electric power generation calculation unit 81 and each of the parameters described above. The efficiency map corresponds to a table indicating a correlation between: the amount of electric power input to the FC converter 3 and each of the parameters described above; and the efficiency, and is obtained in advance through experiments, etc., and stored in the memory. The efficiency of the FC converter 3 may be calculated by determining the ratio of the amount of electric power output from the FC converter 3 to the amount of electric power input to the FC converter 3.

### INDUSTRIAL APPLICABILITY

The fuel cell system 2 according to the present invention is suitable for appropriately controlling an output of a fuel cell.

### DESCRIPTION OF REFERENCE NUMERALS

1 . . . fuel cell system, 2 . . . fuel cell, 3 . . . FC converter, 4 . . . battery, 5 . . . Bat converter, 6 . . . traction inverter, 7 . . . traction motor, 8 . . . control unit, 81 . . . required electric power generation amount calculation unit, 82 . . . lost electric power amount calculation unit, 83 . . . lost electric power amount addition unit, 84 . . . electric power generation request unit, V1, V2 . . . voltage sensors, A1, A2 . . . current sensors, and T . . . temperature sensor.

1. A fuel cell system comprising:
a fuel cell that is supplied with a fuel gas and an oxidant gas and that generates electric power through an electrochemical reaction between the fuel gas and oxidant gas;
a power storage unit that is capable of being charged with the generated electric power of the fuel cell;
an electric power-consuming apparatus that consumes electric power from the fuel cell and/or the power storage unit;
a voltage conversion unit arranged between the fuel cell and the electric power-consuming apparatus;
a required electric power generation amount calculation unit that calculates a required electric power generation amount to be requested to the fuel cell; and
a lost electric power amount calculation unit that calculates a lost electric power amount to be lost in the voltage conversion unit by making use of: an amount of electric power either input to the voltage conversion unit or output from the voltage conversion unit; and a temperature of the voltage conversion unit,
wherein the required electric power generation amount calculation unit is supplemented with the lost electric power amount when calculating the required electric power generation amount.

2. The fuel cell system according to claim 1, wherein the required electric power generation calculation unit is supplemented with the lost electric power amount by adding the lost electric power amount to other amounts of electric power generation included in the required electric power generation amount.

3. (canceled)

4. (canceled)

5. The fuel cell system according to claim 1, wherein the electric power-consuming apparatus includes: a motor serving as a main power source; and an auxiliary apparatus necessary for actuating the fuel cell.
